(19) United States
(12) Patent Application Publication
(10) Pub. No.: US 2019/0270300 A1
(43) Pub. Date: Sep. 5, 2019

(54) TUBULAR MARKING APPARATUS

(71) Applicant: Michael G. Oates, Seabrook, TX (US)

(72) Inventor: Michael G. Oates, Seabrook, TX (US)

(21) Appl. No.: 16/285,544

(22) Filed: Feb. 26, 2019

Related U.S. Application Data
(60) Provisional application No. 62/636,933, filed on Mar. 1, 2018.

(51) Int. Cl. B41F 17/10; B23Q 1/76

(52) U.S. Cl. CPC B41F 17/10; B44D 3/22; B23Q 1/76

(57) ABSTRACT

A marking apparatus for placing a visible marking on a tubular surface at a desired location on its circumference. The marking apparatus can have a base, a guide for aligning a tubular, and a frame securing one or more markers. The marker can place a visible marking on the tubular when the tubular is passed through the frame.

### CROSS REFERENCE TO RELATED APPLICATION

The current application claims priority to and the benefit of co-pending U.S. Provisional Patent Application Ser. No. 62/636,933 filed Mar. 1, 2018 titled “TUBULAR MARKING APPARATUS”. This reference is incorporated herein in its entirety.

### FIELD

The present disclosure generally relates to a marking apparatus for a tubular surface.

### BACKGROUND

Many commercial applications require bending of tubular structures for the installation and/or repair of piping or tubing systems. A typical example of this would be for the installation of conduit, or plumbing systems. Installers will often have to make bends in conduit or piping to fit with other sections or travel around obstacles in the path of the tubing.

The bending of tubulars is often accomplished by using a bending tool and by hand. Because tubulars will often have multiple bends in certain sections, there is much wastage due to human error.

A means of striping or marking the tubular to help align it properly during bending would greatly aid in reducing the amount of wastage.

There is a need, therefore, for an apparatus to mark tubulars in a cost-effective manner at desired positions on the exterior surface in order to aid in the bending process and reduce human error and wasted materials.

The present disclosure addresses the above needs.

### BRIEF DESCRIPTION OF THE DRAWINGS

The detailed description will be better understood in conjunction with the accompanying drawings as follows:

FIG. 1 shows an embodiment of the present disclosure.

FIGS. 2A and 2B depict an alternate embodiment of the frame of the present disclosure.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a marking apparatus for placing a visible marking on a tubular surface at a desired location on the circumference of the tubular.

The marking apparatus can have a base, a guide for aligning a tubular, and a frame securing a marker. The marker can place a visible marking on the tubular when the tubular is passed through the frame.

Tubular can refer to conduit, piping, rod stock, tubing, or any similar structure upon which it is desirable to have a visible marking on the outer circumference for alignment.

The base can be any structure that secures the components in place to enable the marking of a tubular. The base can secure a guide for the tubular and a frame with one or more secured markers properly oriented with each other. The base can comprise a container beneath the marker to capture any shavings that fall from the tubular. In embodiments, the container can be removable to facilitate disposal of the shavings.

In embodiments, a housing can be secured to the base to cover the components of the apparatus. The housing can have entry and exit openings for the tubular and can also comprise a carrying handle for ease of transport.

The guide can align the tubular and position the tubular as desired with respect to the frame and/or marker. The guide can comprise rollers and/or belts in various embodiments. The guide can also have spring loaded elements or comprise a tacky or sticky material in order to grip the tubular and prevent rotation of the tubular.

In embodiments, the guide can be adjustable for aligning multiple sizes of tubulars. Various means can be employed as known to persons having ordinary skill in the art. The guide can have spring loaded rollers, which can be displaced by the tubular, therefore adjusting to various diameters of tubulars. The guide can also be mechanically sizeable, such as by using telescoping or sliding members to expand and contract a receiving area for a tubular.

In embodiments, the apparatus can further comprise a motor in mechanical communication with a roller and/or belt, wherein the roller and/or belt displaces the tubular along the tubular's longitudinal axis. This can help to automate the marking process on a tubular. The apparatus can be designed to plug into a power outlet, use a commonly used corded or cordless drill as the motor, or utilize one or more cordless drill batteries (or other batteries) as the power source for the motor.

The apparatus can have a frame securing a marker. In embodiments, the frame can be adjustable for receiving and/or marking various sizes of tubulars. Similar to the guide, the frame can also be mechanically sizeable, such as by using telescoping or sliding members to expand and contract a receiving area for a tubular.

The frame can secure one or more markers for marking a tubular. In embodiments, the marker can be a hard surface, such as a stone or metal surface for marking the tubular by scratching it. In embodiments, the marker can use ink, paint, dye, lead, or other commonly used means for marking the tubular.

In embodiments, the marker can use a hard surface tip, such as a carbide material, or a diamond material. Portions of the marker can be replaceable as the marker wears over time. In embodiments, the entire marker can be removed, repositioned, and/or replaced.

Multiple markers can be employed to provide several markings on the tubular. While a typical arrangement can have markers, which mark tubulars at a 0°, 90°, 180°, and 270° position on the outer circumference of the tubular, the markers can be positionable; and various angles and number of markings can be utilized based upon the application and type of marking desired.

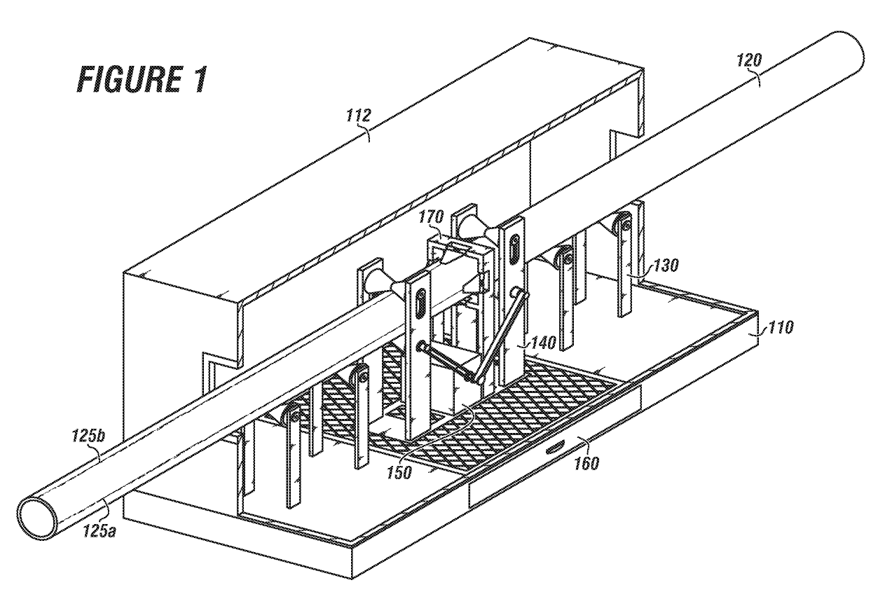

Turning now to the Figures, FIG. 1 shows an embodiment of the present disclosure.

A base 110 can secure a guide 140 for a tubular 120. In embodiments, various supports 130 can be used to align and support the tubular. A motor 150 can be in mechanical communication with the guide 140 to move the tubular along its longitudinal axis. In embodiments, the guide 140 can comprise rollers or a belt. A housing 112 can be used to cover and protect the components.

When a tubular 120 is passed through frame 170 which can secure one or more markers, a visible marking 125a, 125b is placed on the tubular 120. A container 160 can be used to capture any shavings from the tubular 120 or the marker(s).

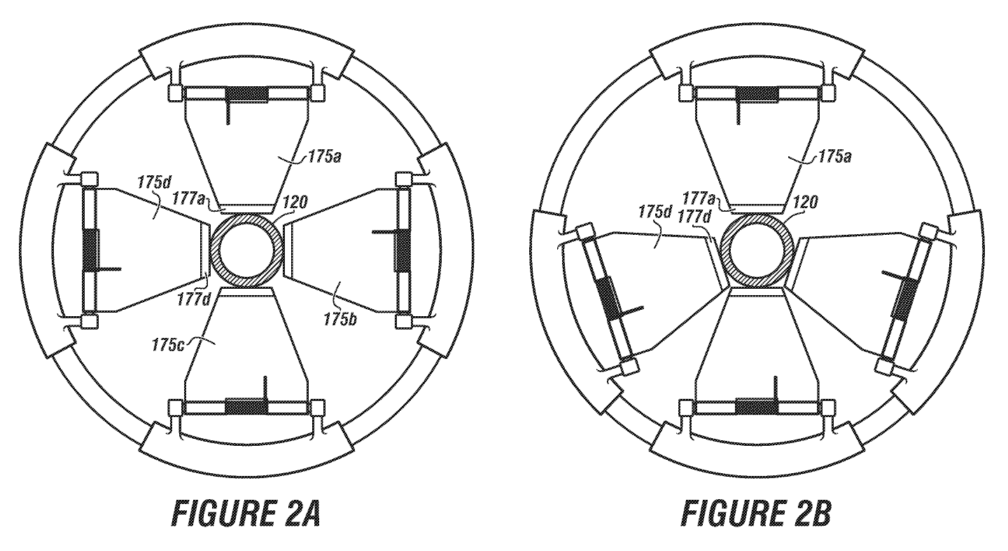

FIGS. 2A and 2B depict an alternate embodiment of the frame of the present disclosure.

A circular frame is shown here. Markers 175a, 175b, 175c, 175d can be secured to the frame for marking the tubular 120. In embodiments, the markers can be spring loaded, as shown, to adjust for various sizes of tubulars and also to provide resistance to facilitate marking of the tubular 120.

In embodiments, the markers 175a, 175b, 175c, 175d can be removed, replaced, or repositioned as desired by the user. A portion of the marker 177a-177d, such as tips, can comprise a hard material designed to scratch the tubular. The portion of the marker 177a-177d can be removable and/or replaceable.

While the present disclosure emphasizes the embodiments, it should be understood that within the scope of the appended claims, the disclosure might be embodied other than as specifically described herein.

What is claimed is:

1. A marking apparatus comprising:
a. a base;
b. a guide for aligning a tubular; and
c. a frame securing a marker, wherein the marker places a visible marking on the tubular when the tubular is passed through the frame.

2. The apparatus of claim 1, wherein the marker comprises a replaceable marking portion.

3. The apparatus of claim 1, wherein the marker is positionable on the frame.

4. The apparatus of claim 1, further comprising a motor in mechanical communication with a roller or a belt, wherein the roller or the belt displaces the tubular along the tubular's longitudinal axis.

5. The apparatus of claim 1, further comprising a container disposed beneath the marker.

6. The apparatus of claim 1, further comprising a housing in mechanical communication with the base, wherein the housing has an entry opening and an exit opening for the tubular.

7. The apparatus of claim 1, wherein the guide is adjustable for aligning multiple sizes of tubulars.

8. The apparatus of claim 1, wherein the frame is adjustable for marking multiple sizes of tubulars.

9. The apparatus of claim 4, wherein a power source for the motor is a battery.

10. The apparatus of claim 1, further comprising at least one secondary marker.

11. The apparatus of claim 4, wherein the motor is a cordless drill.

12. The apparatus of claim 5, wherein the container is removable from the base.

13. The apparatus of claim 10, wherein the at least one secondary marker is oriented such that the tubular is marked with a secondary visible marking at an offset of 90°, 180°, or 270° from the visible marking.

14. The apparatus of claim 10, wherein the at least one secondary marker is positionable.

15. The apparatus of claim 14, wherein the tubular is marked with a secondary visible marking at a user determined offset from the visible marking.
